(19) United States
(12) Patent Application Publication
(10) Pub. No.: US 2011/0172383 A1
(43) Pub. Date: Jul. 14, 2011

(54) Vacuum Devolatilizer

(76) Inventors: Richard Cheng-Ming Yeh, Bellaire, TX (US); Vetkav R. Eswaran, Houston, TX (US)

(21) Appl. No.: 12/972,140

(22) Filed: Dec. 17, 2010

Related U.S. Application Data
(60) Provisional application No. 61/294,891, filed on Jan. 14, 2010.

(51) Int. Cl. C08F 6/28; B01J 19/00; B01D 1/30

(52) U.S. Cl. 526/348; 422/131; 159/16.1

(57) ABSTRACT

Provided is a vacuum devolatilizer for use in a polymer manufacturing or processing plant. The devolatilizer comprises a vacuum chamber having an inlet for a polymer melt, an outlet for a polymer melt, a vacuum port through which volatiles may be removed and a stirrer shaft port for the entry of a stirrer shaft. The stirrer shaft passes through the at least one stirrer shaft port and extends into the vacuum chamber and carries an agitation means. The stirrer shaft seal is associated with each stirrer shaft port for sealing against the stirrer shaft and each stirrer shaft seal has an external portion outside the vacuum chamber. The devolatilizer is provided with a motor located outside of the vacuum chamber for rotating shaft and comprises means for blanketing the external portion of the stirrer shaft seal with a low oxygen content gas or vapor, e.g., nitrogen, helium, steam, or carbon dioxide.

### CROSS REFERENCE TO RELATED APPLICATIONS

This application claims the priority to and the benefit of U.S. Ser. No. 61/294,891, filed Jan. 14, 2010. This application is related to the following concurrently filed U.S. Provisional applications: U.S. Ser. No. 61/294,871 (2010EM001), U.S. Ser. No. 61/294,876 (2010EM004), and U.S. Ser. No. 61/294,885 (2010EM005), each of which was filed Jan. 14, 2010 and each of which is herein incorporated by reference.

### FIELD OF INVENTION

The present disclosure relates to an apparatus for the vacuum devolatilization of polymers. The disclosure furthermore relates to a polymer manufacturing plant or a polymer processing plant comprising a vacuum devolatilizer, and especially to a solution polymerization plant comprising a vacuum devolatilizer.

### BACKGROUND OF INVENTION

In many polymer manufacturing and processing processes it is necessary to remove volatile compounds, such as solvents and residual monomers, from the involatile polymer, and various techniques have been developed for accomplishing that. For example, liquid separation involves adjusting the temperature and pressure of the mixture to a point in the phase diagram where the mixture separates into polymer-lean and polymer-rich phases, and then separating the two phases. Another widely used example is the evaporation of the volatiles in a flash vessel, where the vapor is taken off as an overhead stream and the polymer is collected in the bottom of the vessel, which is provided with an outlet for removal of the polymer therefrom. Such flash chambers are widely used, both in solution polymerization and slurry polymerization. A third technique is vacuum devolatilization in which the molten polymer is exposed to a vacuum while being intensively agitated to draw off volatiles such as solvent and residual monomer, in order to reduce the level of volatiles in the finished polymer to a desired level. Often, a combination of approaches will be used.

One process which produces a polymer-containing reactor effluent from which solvent and residual monomers must be removed is the continuous solution polymerization of olefins.

Continuous solution polymerization processes generally involve the addition of catalyst to a monomer and solvent mixture. The mixture may be back-mixed giving a uniform polymer in an environment with substantially no concentration gradients. WO 94/00500 (Pannell, et al.), incorporated herein by reference, describes a solution polymerization using metallocene in a continuous stirred tank reactor, which may be in a series reactor arrangement to make a variety of products.

The heat of the polymerization reaction can be absorbed by the polymerization mixture, causing an exotherm. Alternatively, or in addition, the heat of reaction can be removed by a cooling system, by external cooling of the walls of the reactor vessel, or by internally arranged heat exchange surfaces cooled by a heat exchange fluid.

In the course of the polymerization, typically, a predominant amount (over 50 mol %) of the monomer is consumed and the polymer formed is dissolved in the solvent. The higher the concentration of the polymer, the higher the viscosity of the polymerization reaction mixture containing the polymer, solvent, and unreacted components. The mixture passes from the polymerization reactor to a finishing section in which polymer, solvent and unreacted monomer are separated. In the course of finishing, solvent and unreacted monomer are progressively removed from the polymerization mixture until the polymer can be formed into a solid pellet or bale. The separated solvent and monomer can be recycled to the polymerization reactor.

The finishing section may also comprise a vacuum devolatilizer.

U.S. Pat. No. 6,881,800 and U.S. Pat. No. 7,163,989, both of which are incorporated herein by reference, describe a process and apparatus for the continuous solution polymerization of olefins including ethylene, propylene and other olefin comonomers. The polymerization reaction takes place under pressure in one or more polymerization reactors, and then the effluent from the reactor or reactors is treated in a finishing section with a catalyst killer and then heated in one or more heat exchangers before being subject to a pressure drop which causes the effluent to phase separate into a polymer-rich phase and a polymer-lean phase. Those phases are separated, with the polymer-lean phase being purified and recycled to be used as solvent. The polymer-rich phase is subject to further separation and purification stages, including passage through a vacuum devolatilizer. Following the vacuum devolatilization, the polymer is formed into pellets and/or bales for storage or shipping. The process is suitable for the manufacture of a range of different polymer types.

In some solution processes (see WO 98/02471 Kolthammer, incorporated herein by reference) the polymerized mixture is flashed off in two stages, whereby the solvent and unreacted monomer are converted to a vapor phase. Efficient extraction of solvent, etc., requires low vapor pressures and vapor phase compression or condensation followed by pumping for subsequent separation stages. Pumping is used to convey polymer from flash separation stages to a final devolatilizing extruder.

In solution plants, solvent selection, operating temperatures, and purification systems have to be designed for a particular operating window for the desired polymerization process. The range of catalyst available permits a wide variety of polymers to be made in terms of comonomer content, molecular weight, etc.

Some polymers produced using solution polymerization or other techniques are soft and tacky, and are therefore prone to handling problems. There is therefore a need for plants and processes which allow improved handling of such soft polymers.

Some polymers are prone to oxidation by atmospheric oxygen, giving rise to gels and other imperfections in the finished product. There is also a need to reduce such gels and other contaminants.

While vacuum devolatilizers have proved themselves effective to reduce the level of residual volatiles in a polymer melt, the devolatilizers and especially the seals thereof have been found to require a high level of maintenance in order to keep working reliably. Conventional mechanical seals having two flat discs, one fixed and one mounted on the shaft with an oil-filled gap between them, have been found to be prone to problems caused by polymer getting between the discs, resulting in failure of the seal and release of the oil into the polymer. There is therefore a need for an improved devolatilizer having improved seals.

Moreover, as many polymer products, especially polymers for films, have end uses which involve contact with food there is a need to ensure that the polymer meets the relevant regulations governing food use, for example, the U.S. Food and Drug Administration (FDA) regulations.

For additional background, see also WO 94/00500 and WO92/14766, both of which are incorporated herein by reference.

### SUMMARY OF INVENTION

Provided is a vacuum devolatilizer for use in a polymer manufacturing or processing plant. The devolatilizer comprises a vacuum chamber having an inlet for a polymer melt, an outlet for a polymer melt, a vacuum port through which volatiles may be removed and a stirrer shaft port for the entry of a stirrer shaft. The stirrer shaft passes through the at least one stirrer shaft port and extends into the vacuum chamber and carries an agitation means, such as paddles. The stirrer shaft seal is associated with each stirrer shaft port for sealing against the stirrer shaft and each stirrer shaft seal has an external portion outside the vacuum chamber. The devolatilizer is provided with a motor located outside of the vacuum chamber for rotating shaft and comprises means for blanketing the external portion of the stirrer shaft seal with a low oxygen content gas or vapor, e.g., nitrogen, helium, steam, or carbon dioxide.

### DESCRIPTION OF THE DRAWINGS

FIG. 1 shows a schematic layout of a continuous solution polymerization plant comprising a devolatilizer according to one embodiment.

FIG. 2 shows schematically in more detail a devolatilizer according to one embodiment.

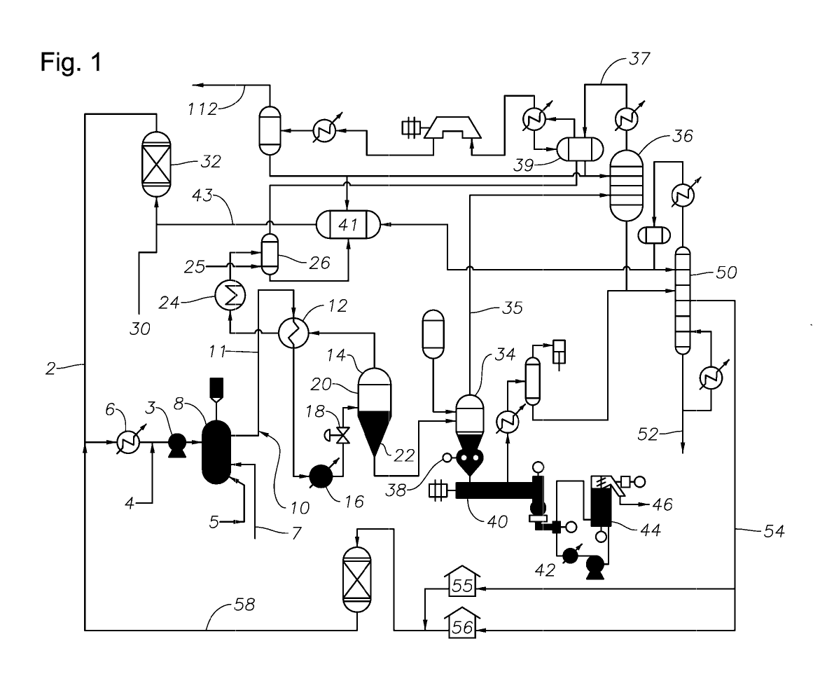

One embodiment of a plant is shown in FIG. 1, the plant is arranged as follows.

### DETAILED DESCRIPTION OF ILLUSTRATIVE EMBODIMENTS

Provided is a vacuum devolatilizer for use in a polymer manufacturing or processing plant comprising: a vacuum chamber having an inlet, an outlet, at least one vacuum port, and at least one stirrer shaft port for the entry of a stirrer shaft, a stirrer shaft passing through the at least one stirrer shaft port and extending into the vacuum chamber, the stirrer shaft carrying an agitation means, such as paddles, a stirrer shaft seal associated with each stirrer shaft port for sealing against the stirrer shaft, each stirrer shaft seal having an external portion outside of the vacuum chamber, and at least one motor located outside the vacuum chamber for rotating the shaft, the devolatilizer further comprising means for blanketing the external portion of at least one stirrer shaft seal with a low oxygen content gas, such as an inert gas.

Without being limited by theory it is believed that the leakage of air into the vacuum chambers of conventional devolatilizers leads to oxidation of the polymer in the chamber, resulting in problems such as black specks and gels in the polymer. In the vacuum devolatilizer described herein, the external portion of the shaft seal is blanketed with a low oxygen content gas, thereby excluding atmospheric oxygen from the area of the seal so that the gas which leaks through the seal is a gas that is inert to the polymer in the chamber, not air.

The term “concentrated polymer phase” as used herein refers to any polymer-containing composition which contains an involatile polymer such as a polyolefin and one or more volatiles which it is desired to separate from the polymer. The concentrated polymer phase will typically comprise at least 70 wt %, preferably at least 80 wt % of polymer.

The term “volatiles” as used herein refers to any non-polymeric species which is capable of being removed from the concentrated polymer phase by heating to a temperature below the decomposition temperature of the polymer and applying a vacuum.

The inlet to and outlet from the vacuum chamber are for the entry of the concentrated polymer phase into and exit of polymer from the vacuum chamber. The agitation means provides agitation of the concentrated polymer phase in the vacuum chamber. The agitation means includes any conventional agitation apparatus known to those skilled in the art. For example, agitation means include one or more: conventional circular or elliptical paddles, conventional blades, conventional rods, or combinations thereof.

The devolatilizer may also comprise a screw shaft associated with the outlet from the vacuum chamber for driving the polymer through the outlet. In that case the vacuum chamber will also have a screw shaft port through which the screw shaft passes into the chamber, and that screw shaft port will also include a screw shaft seal having an external portion outside of the vacuum chamber. Preferably, the devolatilizer also comprises means, such as an enclosure supplied with a low oxygen content gas, for blanketing the external portion of the screw shaft seal with the low oxygen content gas.

The external portion of the stirrer or screw shaft seal is the part of the stirrer or screw shaft seal which is exposed to the atmosphere on the outside of the vacuum chamber. In operation of the devolatilizer of the first aspect of the disclosure, that atmosphere is an atmosphere of a low oxygen content gas.

In one embodiment the devolatilizer vacuum chamber has two stirrer shaft ports and the stirrer shaft extends through each of those two stirrer shaft ports. In that embodiment, the stirrer shaft typically extends all the way through the chamber. In another embodiment, the vacuum chamber has only one stirrer shaft port and the stirrer shaft extends only part-way through the chamber. Any suitable means for blanketing the external portion of each shaft seal with a low oxygen content gas may be used, including a stream of inert gas directed onto the external portion of the seal. Optionally, the means for blanketing the outer face of each shaft seal with a low oxygen content gas is an enclosure around each shaft seal, the enclosure being mounted on the outside of the chamber and being provided with a supply of low oxygen content gas. The enclosure may be fastened to the exterior of the vacuum chamber in any suitable way.

Optionally, in use of the devolatilizer, each enclosure may be maintained under a positive pressure of a low oxygen content gas. In that way, leaks of air into the enclosure are prevented.

Optionally, each enclosure is provided with an inspection hatch. The inspection hatch allows for easy access to the seal for maintenance.

Optionally, each stirrer shaft motor comprises a housing and the housing forms part of an enclosure. Optionally, the stirrer shaft has two motors, each motor being arranged at a respective end of the stirrer shaft, and both motors have a housing, each housing forming part of an enclosure. Where the devolatilizer comprises a screw shaft, the screw shaft will be driven by a motor and optionally the motor comprises a housing which forms part of an enclosure.

Optionally, the devolatilizer includes a flow meter to monitor the flow of low oxygen content gas into each enclosure. In that way, during operation, the flow of the low oxygen content gas into each enclosure may be monitored. An increase in the flow rate of the low oxygen content gas would be an indication of possible failure of the seal. Where there is more than one enclosure, the flow rate of low oxygen content gas into each enclosure is preferably monitored separately by a flow meter dedicated to that enclosure.

Typically, the vacuum chamber is generally cylindrical and is horizontal such that the axis of the cylinder lies in a horizontal plane, and the stirrer shaft also extends horizontally and optionally coincides with axis of the cylinder.

Optionally, each shaft seal is a packed seal and the devolatilizer comprises at least one oil injection pump for injecting lubricating oil into the packed seal. Optionally, the devolatilizer comprises at least one reservoir of lubricating oil for the oil injection pumps. Optionally, the reservoir contains a food grade oil, such as a food grade Royal Purple™ oil.

Optionally, each seal is packed with a packing comprising Kevlar™ fibers (or poly para-phenyleneterephthalamide fibers), PTFE (polytetrafluoroethylene) and graphite. Optionally, each seal is packed with a packing comprising Kevlar or graphite impregnated with PTFE.

The provided apparatus and process use any suitable low oxygen content gas. Preferably, the low oxygen content gas has less than 3 wt. % oxygen, preferably less than 0.5 wt. % oxygen. More preferably, the low oxygen content gas is substantially free or free (0.0 wt. %) of oxygen. Low oxygen content gases include conventional gases that do not contain oxygen, such as helium, argon, nitrogen, steam, carbon dioxide, or combinations thereof. Preferably, the low oxygen content gas is nitrogen.

Optionally, the internal volume of the vacuum chamber is at least 2 m³, for example, at least 4 m³ and is optionally at most 15 m³, for example 11 m³. Optionally, the vacuum chamber is generally cylindrical with a length of at least 4 m, optionally at least 6 m, and a diameter of at least 1 m.

Typically, the vacuum devolatilizer comprises or is connected to at least one pump for applying a vacuum to the vacuum chamber via the vacuum port or vacuum ports.

In a second aspect a polyolefin manufacturing plant is provided comprising a vacuum devolatilizer as described herein.

The plant may be any type of polyolefin manufacturing plant in which it is desired to remove volatiles from a concentrated polymer phase such as a polymer melt. Optionally, the plant is a plant for the continuous solution polymerization of one or more olefin monomers in a hydrocarbon solvent.

In a third aspect, provided is a process of removing volatile components from a concentrated polymer phase comprising: introducing the concentrated polymer phase into a vacuum devolatilizer comprising: a vacuum chamber having an inlet, an outlet, at least one vacuum port, and at least one stirrer shaft port for the entry of a stirrer shaft, a stirrer shaft passing through the at least one stirrer shaft port and extending into the vacuum chamber, the stirrer shaft having an agitation means for agitation of a concentrated polymer phase in the vacuum chamber, a stirrer shaft seal associated with each stirrer shaft port for sealing against the stirrer shaft, each stirrer shaft seal having an external portion outside of the vacuum chamber, at least one motor located outside the vacuum chamber for rotating the stirrer shaft, and the devolatilizer further comprising means for blanketing the external portion of at least one stirrer shaft seal with a low oxygen content gas, wherein the process further includes introducing a concentrated polymer phase into the vacuum chamber, applying a vacuum through the at least one vacuum port while rotating the stirrer shaft, thereby agitating the concentrated polymer phase, and blanketing the external portion of at least one of the stirrer shaft seals with a low oxygen content gas.

In a fourth aspect, provided is a vacuum devolatilizer for use in a polymer manufacturing or processing plant comprising: a vacuum chamber having an inlet, an outlet, at least one vacuum port, and at least one stirrer shaft port for the entry of a stirrer shaft, a stirrer shaft passing through the at least one stirrer shaft port and extending into the vacuum chamber, the stirrer shaft carrying an agitation means, a stirrer shaft seal associated with each stirrer shaft port for sealing against the shaft, and at least one motor located outside the vacuum chamber for rotating the stirrer shaft, in which each stirrer shaft seal is a packed seal and is provided with a dedicated oil injection pump for injecting lubricating oil into the stirrer shaft seal.

In a fifth aspect is provided a polyolefin manufacturing plant comprising a vacuum devolatilizer according to the fourth aspect of this disclosure. The plant may be any plant in which it is desired to remove volatiles from a concentrated polymer phase. Optionally, the plant is a plant for the continuous solution polymerization of one or more olefin monomers in a hydrocarbon solvent. Typically, the plant comprises at least one pump for applying a vacuum to the vacuum chamber via the vacuum port or vacuum ports.

The devolatilizer may also comprise a screw shaft associated with the outlet from the vacuum chamber for driving the polymer through the outlet. In that case the vacuum chamber will also have a screw shaft port through which the screw shaft passes into the chamber, and that screw shaft port will also include a screw shaft seal having an external portion outside of the vacuum chamber. Preferably, the devolatilizer also comprises means, such as an enclosure supplied with low oxygen content gas, for blanketing the external portion of the screw shaft seal with a low oxygen content gas.

In the devolatilizer of the fourth aspect, the screw shaft seal will also preferably be a packed seal and be provided with a dedicated oil injection pump for injecting the lubricating oil into that seal.

In conventional vacuum devolatilizers, mechanical seals are often used. Those mechanical seals typically comprise a disc which fits closely against a corresponding disc attached to the shaft, with the gap in between being filled with a lubricant. However, a polymer gets between the discs then the seal can fail, with the lubricating oil then running into the chamber and contaminating the polymer.

In the devolatilizer of the fourth aspect, at least one and preferably all of the shaft seals are packed seals. In packed seals, a flexible packing material such as Kevlar rope (braided aramid fiber) is compressed against the shaft to provide a seal. Packed seals typically include means for lubricating the packed seal and in the devolatilizer of the fourth aspect each packed shaft seal is provided with its own dedicated oil injection pump for injecting oil into the packed seal. Thus, in a devolatilizer having three packed shaft seals (two for the stirrer shaft and a third for a screw shaft for driving the polymer out of the devolatilizer) there will be three injection pumps, each pump serving one seal. In that way, if one of the seals fails and leaks oil, only that seal will be affected, and the other seals will not be starved of oil.

Packed seals are furthermore generally easier to change than mechanical seals.

Optionally, the devolatilizer comprises a reservoir containing a food grade oil for injection into the packaging of each shaft seal. In that way, any small leakage of the oil into the vacuum chamber will not result in the polymer being deemed unacceptable for food use. Preferably, the oil is an oil available from Royal Purple. Preferably, the pumps each include a pressure monitoring device for monitoring the pressure of the oil.

Any suitable packing material may be used for packing the seal or seals. The packing material should be capable of operating under the temperatures and pressures experienced in the vacuum devolatilizer, without requiring replacement in an excessively short time. In one embodiment the packing material is in the form of a rope which can be cut to the required length to wrap around the shaft. Optionally, each shaft seal packed with a packing comprising one or more of Kevlar fibers, PTFE (polytetrafluoroethylene) and graphite. Optionally, the Kevlar or aramid or carbon fiber is impregnated with PTFE or graphite to help reduce friction and enable the shaft to rotate smoothly.

Each seal is advantageously a multistage seal. Optionally, each seal is a three stage seal.

Optionally, the devolatilizer comprises a switching device for automatically switching the oil injection from the space between the innermost and middle packing to the space between the middle and outermost packing in a cycle.

Optionally, a low oxygen content gas, preferably nitrogen, is injected into the space between the middle and the outermost packing

Optionally, each seal comprises a packing which comprises a set of 2 to 10, preferably 3 to 6, braided packing ropes.

Optionally, the oil is injected using a plunger pump or syringe pump whereby a fixed quantity of oil is delivered for a given period of time.

Optionally, the vacuum chamber has two stirrer shaft ports and the stirrer shaft extends through each of those two shaft ports, and each stirrer shaft port has a packed seal, the devolatilizer further comprising two oil injection pumps, each oil injection pump being arranged to pump oil into the packing of a respective one of the stirrer shaft seals.

Optionally, the means for blanketing the external portion of each shaft seal with a low oxygen content gas is an enclosure around each shaft seal, the enclosure being mounted on the outside of the housing and being provided with a supply of a low oxygen content gas.

Optionally, each enclosure may be maintained under a positive pressure of the low oxygen content gas with respect to the atmospheric pressure in the area adjacent to the enclosure.

Optionally, each enclosure is provided with an inspection hatch.

Optionally, the devolatilizer includes a flow meter to monitor the flow of low oxygen content gas into each enclosure.

Optionally, the vacuum chamber is generally cylindrical and is horizontal such that the axis of the cylinder lies in a horizontal plane, and the shaft also extends horizontally and coincides with axis of the cylinder.

The process of all aspects of the invention(s) described herein can be performed with any suitable catalyst. For example, the process can utilize any SSC (single sited catalyst). These generally contain a transition metal of Groups 3 to 10 of the Periodic Table, and at least one ancillary ligand that remains bonded to the transition metal during polymerization. Preferably, the transition metal is used in a cationic state and stabilized by a cocatalyst or activator. Especially preferred are metallocenes of Group 4 of the Periodic table such as titanium, hafnium or zirconium which are used in polymerization in the d⁰ monovalent cationic state and have one or two ancillary ligands as described in more detail hereafter. The important features of such catalysts for coordination polymerization are the ligand capable of abstraction and that ligand into which the ethylene (olefinic) group can be inserted.

For the purposes of this patent specification the term “metallocene” is herein defined to contain one or more cyclopentadienyl moiety in combination with a transition metal of the Periodic Table of Elements.

The metallocene can be used with a cocatalyst which may be alumoxane preferably methylalumoxane having an average degree of oligomerization of from 4 to 30 as determined by vapor pressure osmometry. Alumoxane may be modified to provide solubility in linear alkanes or be used in a slurry but is generally used from a toluene solution. Such solutions may include unreacted trialkyl aluminum and the alumoxane concentration is generally indicated as mol Al per liter, which figure includes any trialkyl aluminum which has not reacted to form an oligomer. The alumoxane, when used as cocatalyst, is generally used in molar excess, at a mol ratio of 50 or more, preferably 100 or more, and preferably 1000 or less, preferably 500 or less, relative to the transition metal.

The process and the plant used in the process are designed as explained above to permit polymerization of a wide variety of polymer types and molecular weights. Generally speaking the polymers are derived from either ethylene or propylene as the dominant (more than 50 mol %) component. Polymers may preferably contain from 5 to 45 mol % of comonomer to vary crystallinity and flexibility. The comonomers may be alpha-olefins (under which term cyclic olefins such as styrene are included) having from 2 to 20 carbon atoms, such as ethylene (in the case of the polymer consisting predominantly of propylene derived units) 1-butene, 1-hexene, and 1-octene. Amounts of dienes such as hexadiene, vinyl norbornene, ethylidene norbornene (ENB), norbornadiene, etc., may be included to promote unsaturation and/or the formation of longer branches themselves made from polymerized monomer derived units.

In the case of plastomer, the polymer which may be produced include the following aspects: Preferably the comonomer is an alpha-olefin having from 3 to 15 carbon atoms, more preferably 4 to 12 carbon atoms and more preferably 4 to 10 carbon atoms. Ethylene can be polymerized with at least two comonomers to form a terpolymer. Monomer is generally polymerized in a proportion of 70.0-99.99, preferably 70-90 and more preferably 80-95 or 90-95 mol % of ethylene with 0.01-30, preferably 3-30 and more preferably 5-20 mol % comonomer. For the purposes of this patent specification the molecular weight distribution of a polymer can be determined with a Waters Gel Permeation Chromatograph equipped with Ultra-styrogel 5 columns and a refractive index detector. The operating temperature of the instrument was set at 145° C., the eluting solvent was trichlorobenzene, and the calibration standards included sixteen polystyrenes of precisely known molecular weight, ranging from a molecular weight of 500 to a molecular weight of 5.2 million, and a polyethylene standard, NBS 1475.10. The molecular weight distribution (MWD) of the plastomers produced by the process described herein are termed “narrow” that is to say an M_{w}/Mₙ less than 3, preferably less than or equal to 2.5. The MI of the polymers are generally in the range of 0.01 dg/min to 200 dg/min, preferably 0.1 dg/min to 100 dg/min, more preferably 0.2 dg/min to 50 dg/min and more preferably less than 10 dg/min. Contemplated densities of the plastomers are in the range of 0.85 g/cm³ to 0.93 g/cm³, preferably 0.87 g/cm³ to 0.92 g/cm³, more preferably 0.88 g/cm³ to 0.91 g/cm³.

The process can be especially concerned with copolymerization reactions involving the polymerization of one or more of the monomers, for example alpha-olefin monomers of ethylene, propylene, 1-butene, 1-pentene, 1,4-methyl-1-pentene, 1-hexene, 1-octene, 1-decene and cyclic olefins such as styrene. Other monomers can include polar vinyl, dienes, norbornene, acetylene and aldehyde monomers.

In the case of elastomers, the polymer which may be produced include terpolymers of an ethylene-α-olefin-EODE (Ethylene-alpha-Olefin-Diene Elastomer) of high weight average molecular weight (M_{w}) and greater than 0.3 wt % diene content, preferably greater than 2.0 wt % diene content. These polymers may be largely amorphous and have a low or zero heat of fusion. As used herein the term “EODE” encompasses elastomeric polymers comprised of ethylene, alpha-olefin, and one or more non-conjugated diene monomers. The non-conjugated diene monomer can be a straight chain, branched chain or cyclic hydrocarbon diene having from 6 to 15 carbon atoms. Examples of suitable non-conjugated dienes are straight chain acyclic dienes such as 1,4-hexadiene and 1,6-octadiene; branched chain acyclic dienes such as 5-methyl-1,4-hexadiene; 3,7-dimethyl-1,6-octadiene; 3,7-dimethyl-1,7-octadiene and mixed isomers of dihydromyricene and dihydroocinene; single ring alicyclic dienes such as 1,4-cyclohexadiene; and 1,5-cyclododecadiene; and multi-ring alicyclic fused and bridged ring dienes such as tetrahydroindene, methyl tetrahydroindene, dicyclopentadiene; bicyclo-1,5-(2,2,1)-hepta-2,5-diene; alkenyl, alkylidene, cycloalkylidene norbornenes such as 5-methylene-2-norbornene (MNB); 5-propenyl-2-norbornene, 5-isopropylidene-2-norbornene, 5-(4-cyclopentenyl)-2-norbornene, 5-cyclohexylidene-2-norbornene, 5-vinyl-2-norbornene and norbornadiene.

Of the dienes typically used to prepare EPDMs, the particularly preferred dienes are, 1,4-hexadiene (HD), 5-ethylidene-2-norbornene (ENB), 5-vinylidene-2-norbornene (VNB), 5-methylene-2-norbornene (MNB), and dicyclopentadiene (DCPD). The especially preferred dienes are 5-ethylidene-2-norbornene (ENB) and 1,4-hexadiene (HD). The preferred EOD elastomers may contain 20 wt % up to 90 wt % ethylene, more preferably 30 wt % to 85 wt % ethylene, more preferably 35 wt % to 80 wt % ethylene. The alpha-olefin suitable for use in the preparation of elastomers with ethylene and dienes are preferably propylene, 1-butene, 1-pentene, 1-hexene, 1-octene and 1-dodecene. The alpha-olefin is generally incorporated into the EODE polymer at 10 wt % to 80 wt %, more preferably at 20 wt % to 65 wt %. The non-conjugated dienes are generally incorporated into the EODE at 0.5 wt % to 20 wt % to 35 wt %; more preferably at 1 wt % to 15 wt %, and more preferably at 2 wt % to 12 wt %. If desired, more than one diene may be incorporated simultaneously, for example HD and ENB, with total diene incorporation within the limits specified above.

The elastomers may also be devoid of a diene and be a copolymer of two monomer types. Such copolymers may be elastomers of high M_{w}, low crystallinity, and low ash. The copolymers may be ethylene-alpha-olefin copolymers (EPC) of high M_{w}. As used herein the term “EPC” means a copolymer of ethylene and an alpha-olefin, not necessarily propylene, which exhibits the properties of an elastomer. The alpha-olefins suitable for use in the preparation of elastomers with ethylene are preferably C₃-C₁₀ alpha-olefins. Illustrative non-limiting examples of such alpha-olefins are propylene, 1-butene, 1-pentene, 1-hexene, 1-octene and 1-dodecene. If desired, more than one alpha-olefin may be incorporated. The EPC elastomers may contain 20 wt % up to 90 wt % ethylene, more preferably 30 wt % to 85 wt % ethylene, and more preferably 35 wt % to 80 wt % ethylene.

In the case of polymers derived predominantly from propylene derived units, the polymers have the following features as a result of the presence of isotactic polypropylene sequences in the chain.

In one embodiment, a copolymer of propylene and at least one comonomer, the comonomer being ethylene or an alpha-olefin. Comonomers include ethylene and linear or branched C₄ to C₃₀ alpha-olefins, or combinations thereof. Preferred linear alpha-olefins include ethylene and C₄ to C₈ alpha-olefins, more preferably ethylene, 1-butene, 1-hexene, and 1-octene, even more preferably ethylene or 1-butene. Preferred branched alpha-olefins include 4-methyl-1-pentene, 3-methyl-1-pentene, and 3,5,5-trimethyl-1-hexene. The propylene copolymer is preferably a random copolymer, as the term is defined herein below.

The polypropylene copolymer has a crystallinity of from 2% to 65%. Within this range of crystallinity, alternative lower limits of crystallinity can be 5% or 10%, and alternative upper limits of crystallinity can be 50%, 45% or 40%.

The crystallinity of the polypropylene copolymer is derived from isotactic (or alternatively syndiotactic) polypropylene sequences in the copolymer. The amount of propylene can be from 65 wt % to 95 wt %. Within this range, alternative lower limits of propylene content can be 70 wt % or 80 wt %, and alternative upper limits of propylene content can be 92.5 wt %, 90 wt %, or 89 wt %.

The semi-crystalline polypropylene copolymer necessarily has a non-zero heat of fusion, due to the measurable crystallinity. The crystallinity can be calculated from the heat of fusion, using a preferred value of 189 J/g for 100% crystallinity and a linear relationship between heat of fusion and crystallinity; see, B. Wunderlich, Macromolecular Physics, vol. 3, Academic Press (1980), esp. Chapter 8.4.2, incorporated herein by reference.

The polypropylene copolymer preferably has a single broad melting transition. Typically, a sample of the polypropylene copolymer will show secondary melting peaks or shoulders adjacent to the principal peak, and this combination is considered together as single melting point, i.e., a single broad melting transition. The highest of these peaks is considered the melting point. The polypropylene copolymer preferably has a melting point of from 25° C. to 110° C. Within this range, alternative lower limits of the melting point can be 30° C. or 35° C., and alternative upper limits of the melting point can be 105° C. or 90° C.

The M_{w} of the polypropylene copolymer can be from 10,000 to 5,000,000 g/mol, preferably 80,000 to 500,000. The MWD is preferably above 2. The MWD may be less than 40, more preferably less than 5 and more preferably less than 3. In another embodiment, it is preferred that the polypropylene copolymer has a ML (1+4)@125° C. less than 100, more preferably less than 75, even more preferably less than 60, more preferably less than 30.

The polypropylene copolymer produced by the process preferably is a random, crystallizable copolymer having a narrow compositional distribution. The intermolecular composition distribution of the polymer is determined by thermal fractionation in a solvent. A typical solvent is a saturated hydrocarbon such as hexane or heptane. The thermal fractionation procedure is described below. Typically, approximately 75 wt % and more preferably 85 wt % of the polymer is isolated as one or two adjacent, soluble fractions, with the balance of the polymer in immediately preceding or succeeding fractions. Each of these fractions has a composition (wt % ethylene content) with a difference of no greater than 20% (relative) and more preferably no greater than 10% (relative) from the average wt % ethylene content of the polypropylene copolymer. For purposes of the present disclosure, the polypropylene copolymer is considered to have a “narrow” compositional distribution if it meets the fractionation test outlined above.

The length and distribution of stereoregular propylene sequences in preferred polypropylene copolymers is consistent with substantially random statistical copolymerization. It is well known that sequence length and distribution are related to the copolymerization reactivity ratios. As used herein, the term “substantially random” means a copolymer for which the product of the reactivity ratios is generally 2 or less. In contrast, in stereoblock structures, the average length of PP sequences is greater than that of substantially random copolymers with a similar composition. Prior art polymers with stereoblock structure have a distribution of PP sequences consistent with these “blocky” structures rather than a random, substantially statistical distribution.

The reactivity ratios and sequence distribution of the polymer may be determined by C-13 NMR, which locates the ethylene residues in relation to the neighboring propylene residues. To produce a crystallizable copolymer with the required randomness and narrow composition distribution, it is desirable to use: (1) a single-sited catalyst; and (2) a well-mixed, continuous flow, stirred tank polymerization reactor which allows only a single polymerization environment for substantially all of the polymer chains of preferred polypropylene copolymers.

### Polymerization and Initial Separation of Polymer and Solvent

A feed for polymerization is passed through conduit 2 by a centrifugal pump 3. The feed contains: A) hexane as solvent, B) monomer, generally the predominant monomer is ethylene or propylene, and C) comonomer which may be any copolymerizable alpha-olefin, and D) a diene or other polyene or cyclic copolymerizable material. The feed is passed through a chiller or cooler 6 in which the feed is optionally chilled to a low temperature for subsequent adiabatic polymerization in the two continuous stirred tank reactors 8 which are operated in series (for simplicity, only one reactor is depicted in FIG. 1). Activator and metallocene catalyst may be premixed and added at 5 and/or 7 to one or both reactors 8. A scavenger, generally in the form of an alkyl aluminum such as tri-isobutyl aluminum or tri-n-octyl aluminum is next added at 4 to minimize the impact of poisons in the feed and in the reactor on the catalyst activity.

The feed temperature may vary depending on the available exotherm and extent of monomer conversion desired to reach the polymerization temperature. Advantageously the temperature is no higher than 40° C., optionally no higher than 20° C., optionally no higher than 0° C., optionally no higher than −20° C., and optionally is less than −20° C., for example in the range of from −20° C. to −40° C.

To complement the molecular weight control provided by controlling the polymerization temperature, hydrogen may be added to one or both reactors through conduits (not shown).

Working pressures in the reactors can be 80 bar or more, 90 bar or more, 95 bar or more, and especially 120 bar or more, or even 140 bar or more. The upper pressure limit is not critically constrained but typically can be 200 bar or less, preferably 140 bar or less, or 120 bar or less. The pressure should suffice to keep the reactor solution in a single phase up to the point of the pressure reducing means 18, and to provide the necessary working pressure to convey the fluids through the plant.

The solution, containing polymer, which emerges from the reactors 8 through a conduit 11, is first treated with a catalyst killer, preferably water, or in some cases preferably methanol, added at 10 in a molecular solution in hexane solvent to terminate the polymerization reaction. A heat exchanger 12 is arranged as part of a heat integrating arrangement and heated by a lean phase emerging from an upper layer 20 in a liquid phase separator 14, and provides an initial increase in the temperature of the polymer solution in the conduit 11. A trim heat exchanger 16, operating by using steam, hot oil or other high temperature fluid, further increases the temperature to a level suitable for liquid phase separation. The solution then passes through a let down valve 18 where a pressure drop is created which causes the separation of the polymer solution and settlement into the lean phase 20 and a polymer rich phase 22 below it.

### Treatment of Lean Phase

The lean phase 20, after being cooled by the heat exchanger 12, aforementioned, is cooled further by a cooling device 24, passed through a surge tank 26 adapted for stripping out the hydrogen and then submitted to in-line chemical analysis at 43 to determine the concentration of monomer and comonomer in the solvent. This cooled lean phase 43 is combined with fresh feed of solvent and monomer 30 to provide the desired concentrations and then passed through a drier 32 which serves to remove any unreacted water used as the catalyst killer or present in the fresh feed supplied or any impurity in the recycled solvent and monomer.

The surge tank 26 is arranged in the form a vessel 26 suitable for stripping out hydrogen by means of ethylene as a stripping vapor as is shown in FIG. 3 of U.S. Pat. No. 6,881,800, incorporated herein by reference.

The vapor from vessel 26 is routed to the reflux drum 39 of tower 36. Partly it is processed to recover valuable components, principally volatile monomers such as ethylene and propylene, by fractionating tower 36 and its overhead vapor compression/condensation system for recycling through conduit 43 to the inlet side of the drier 32. The part mainly comprising hydrogen and any other non-condensables may be flared at 112.

### Treatment of Polymer-Rich Phase

The polymer-rich phase is passed to a low-pressure separator 34 where evaporated solvent and monomer are separated from the polymer rich phase emerging from the liquid phase separator 14 to form a concentrated polymer phase. That concentrated polymer phase may, for example, comprise from 70 wt % to 95 wt % of polymer, with the rest being volatiles such as solvent and residual monomers.

The evaporated solvent and monomer phase is passed through conduit 35 in a vapor phase to the purification tower 36 operating by distillation to separate a light fraction of the highly volatile solvent and unreacted ethylene and propylene on the one hand and heavier less volatile components such as hexane and any toluene used to dissolve catalyst or activator and unreacted diene type comonomers on the other hand. Use of toluene can be reduced under appropriate circumstances by a suitable selection of catalyst components and catalyst preparation conditions such as increases in catalyst solution temperature to increase the solubility of the catalyst components to reach a point where so little toluene is present that no separate process for the removal of the toluene are required.

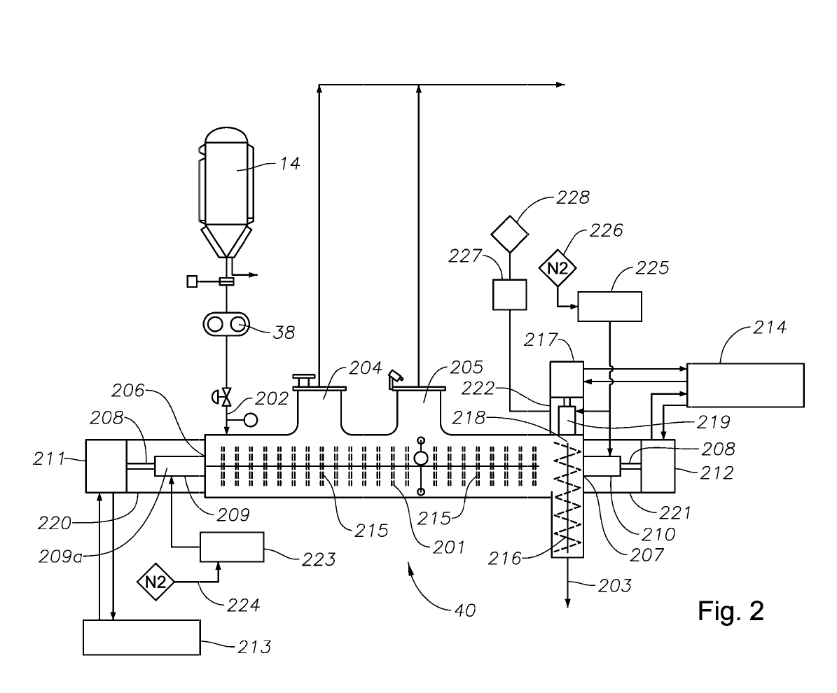

A gear pump 38 conveys the concentrated polymer phase leaving the flash tank 34 to a vacuum devolatilizer which is shown in more detail in FIG. 2 and is described below. In the devolatilizer 40 a vapor phase is drawn off for purification, condensed and then pumped to a purification tower 50. A heavy fraction of toluene used as catalyst solvent and diene such as ethylene norbornadiene (ENB) comonomer or 1-octene comonomer are recovered by this purification tower 50. The ENB or octene can be recycled through outlet 54. Alternative heavy comonomers, such as ENB and octene, may thereby be stored in separate storage vessels 55, 56, which facilitates rapid product transitions between different product families (e.g. EP(D)M and EO plastomers), while still enabling eventual recovery of the valuable unreacted comonomers.

The polymer melt emerging from 40 can then be pelletized in an underwater pelletizer, fed with water chilled at 42, washed and spun dried at 44 to form pellets suitable for bagging or baling at 46.

FIG. 2 shows the arrangement of the devolatilizer 40 in more detail. The devolatilizer 40 includes a vacuum chamber 201 which is provided with an inlet 202 for concentrated polymer phase coming from low pressure flash vessel 14 via gear pump 38, an outlet 203 for concentrated polymer flowing to the pelletizer 46 (not shown in FIG. 2) and two vacuum ports 204 and 205 which are connected via conduits (not shown) to a vacuum system comprising a pump. The vacuum chamber 201 is generally cylindrical having a length of approximately 2 to 10 meters and a diameter of over 1 meter. The vacuum chamber 201 is horizontally mounted and is provided at each end with a stirrer shaft port 206, 207. Extending horizontally through the stirrer shaft ports 206, 207 and being coaxial with the axis of the cylindrical vacuum chamber 201 is stirrer shaft 208. Stirrer shaft port 206 is provided with a stirrer shaft seal 209 for sealing between the vacuum chamber 201 and the stirrer shaft 208. Stirrer shaft port 207 is provided with a similar stirrer shaft seal 210. The function of stirrer shaft seals 209 and 210 is to prevent ingress of the atmosphere external to the vacuum chamber 201 into the interior vacuum chamber 201. The vacuum devolatilizer 40 further includes two hydraulic motors 211, 212 mounted at the ends of the stirrer shaft 208 for driving the stirrer shaft 208. Those motors 211, 212 are powered by separate hydraulic drives 213 and 214, respectively. Stirrer shaft 208 is provided along its length with a number of paddles 215 for agitating the polymer inside the vacuum chamber 201.

At the end of the vacuum chamber 201 remote from the inlet 202 a horizontally mounted screw shaft 216 is mounted orthogonal to the stirrer shaft 208 (in FIG. 2 the screw shaft appears in a vertical direction for clarity). Screw shaft 216 is driven by hydraulic motor 217 which is powered by hydraulic drive 214. The function of screw shaft 216 is to drive polymer out of the vacuum chamber 201 and through the outlet 203 towards the downstream pelletizer. The screw shaft 216 enters the vacuum chamber through a screw shaft port 218 which is provided with a screw shaft seal 219.

Each of the shaft seals 209, 210 and 219 is a three stage seal packed with a packing material comprising braided Kevlar™ fibers, impregnated with PTFE and graphite as the main packing Seal 209 has a portion 209a which extends outside the vacuum chamber 201. That external portion 209a of the seal 209 is contained within enclosure 220 which is a cylindrical enclosure extending from the end of the vacuum chamber 201 to the housing of the motor 211. When the devolatilizer 40 is in operation that enclosure 220 is supplied with nitrogen from a nitrogen source (not shown) to maintain an inert atmosphere within the enclosure 220, thereby blanketing the external portion 209a of the seal 209 with the inert atmosphere. In that way, any leak in seal 209 draws nitrogen from the interior enclosure 220 into the interior of the vacuum chamber 201 rather than air from the atmosphere. The nitrogen supply to enclosure 220 is monitored by a monitor (not shown) so that any sudden rises of nitrogen flow out of the enclosure 220 will be detected as an indication of a possible leak in the seal 209. In a similar way, stirrer shaft seal 210 has a portion which extends external to the vacuum chamber 201 which is enclosed inside nitrogen-filled enclosure 221, and the screw shaft seal 219 has a portion which extends external to the vacuum chamber 201 which is enclosed inside nitrogen-filled enclosure 222. Enclosures 221 and 222 have their own independent supplies of nitrogen (not shown) with their own independent monitors for detecting any increase in the flow of nitrogen to those enclosures.

As can be seen from FIG. 2, each of the motors 211, 212 and 217 has a housing which forms part of the enclosures 220, 221 and 222, respectively.

Each of the enclosures 220, 221 and 222 is also provided with an inspection hatch (not shown) through which an operator can access the seals 209, 210 and 219 for maintenance and repacking

Seal 209 is provided with a dedicated oil injection pump 223 which feeds Royal Purple™ lubricant oil into the seal 209, thereby improving the sealing action and extending the lifetime of the seal packing Pump 223 is an air driven plunger pump which meters an exact quantity of oil to the seal for each stroke thereby ensuring that excessive oil is not injected into the seal. Oil flow is carefully controlled to limit the ingress of seal oil into certain polymers that may be used for making packaging materials for foods. Alternately, the oil may be pressurized with nitrogen supply 224 which applies a pressure to a reservoir of lubricant oil thereby forcing the oil at a specified pressure into the seal 209.

Optionally, an oil flow meter (not shown) is also provided in the conduit leading from pump 223 to seal 209 so that any oil leak in the seal 209 can be detected. In a similar way seal 210 is provided with an oil pump 225 and an associated air supply or nitrogen supply 226, and seal 219 is provided with an oil pump 227 having an associated nitrogen supply 228.

Optionally, each of the three stage seals on both ends of the stirrer shaft and the discharge screw shaft has two ports, one port between the 1^{st} and 2^{nd} stages and a second port between the 2^{nd} and 3^{rd} stages. Seal oil is injected via the 2^{nd} port when the devolatilizer vacuum chamber is at a lower pressure than the ambient pressure. This way, the seal oil is drawn preferentially toward the middle packing and thereby lubricates it. After a set period, for example, 10 minutes to 12 hours, preferably 10 minutes to 2 hours, the oil is injected into the 1^{st} port so that the first stage packing gets lubricated. The oil injection is then switched back to the first port, via automatic valves (not shown) after a period of 1 minute to 12 hours, preferably 1 minute to 1 hour. This cycle is repeated as long as the equipment is in operation, switching back and forth to ensure that the packings are well lubricated. When the devolatilizer is not processing polymer, such as for example when changing from one type of polymer to another or for maintenance elsewhere in the plant, the chamber is advantageously blanketed with a positive pressure, that is, above ambient pressure, preferably of between 0.25 to 10 psig (1.72 to 68.95 kilopascals), more preferably of between 0.5 and 5 psig (3.45 to 34.47 kilopascals), and the seal oil is injected between the 1^{st} and 2^{nd} seals, whereby the second packing continues to get lubricated.

A low oxygen content gas, preferably nitrogen, is injected into the second port, that is, between the middle packing and the outer packing, that is the packing furthest away from the vacuum chamber. This ensures that any small leakage in the dynamic seal between the packing and the rotating shafts is not oxygen- and moisture-containing ambient air. Humid air is a problem because it condenses and forms ice in the hydrocarbon recovery system. Oxygen is a problem because it degrades the polymer and may present a safety hazard.

During operation of the devolatilizer 40 a concentrated polymer phase comprising between 10 wt % and 30 wt % of volatiles (mainly solvent with a small amount of residual monomer) flows from the bottom of low pressure flash tank 14 through gear pump 38 and into inlet 202 of vacuum chamber 201. Inside the vacuum chamber the concentrated polymer phase is agitated by the paddles 215 fixed to stirrer shaft 208 which rotates at a speed of between 20 and 45 rpm. That agitation continuously exposes new surface of the polymer inside the vacuum chamber 201 and volatile material is drawn off through the two vacuum ports 204, 205 toward the vacuum system (not shown), the vacuum is maintained inside the vacuum chamber 201 at a pressure of approximately 20 mmHg. The polymer flows along the length of the vacuum chamber 201 and is driven out of the end of vacuum chamber 201 by rotating screw shaft 216 through outlet 203 towards the downstream pelletizer 46.

As the stirrer shaft 208 rotates a small low level of gas leakage through seals 209 and 210 occurs, thereby drawing nitrogen from enclosures 220 and 221 into the interior of vacuum chamber 201. The presence of enclosures 220 and 221 prevents any oxygen from the air outside the devolatilizer from entering the vacuum chamber 201 through the stirrer shaft seals 209 and 210. Similarly the enclosure 222 prevents air being drawn in through screw shaft seal 219.

During rotation of the shaft 208 and the screw shaft 216 lubricant oil is provided to the respective shaft seals by the dedicated oil injection pumps 223, 225 and 227. Should any of those seals fail, the pressure of the oil to that seal will drop and the flow rate will increase thereby allowing early detection of the leak. The oil flow to the other seals will be unaffected.

The oil injection is switched periodically into the 1^{st} port and then into the 2^{nd} port and the cycle is repeated.

Nitrogen or other low oxygen content gas is also injected into the space between the 2^{nd} and 3^{rd} packing via its own port or via the same port as the oil injection port.

All documents cited herein are fully incorporated by reference for all jurisdictions in which such incorporation is permitted and to the extent they are not inconsistent with this specification. All documents to which priority is claimed are fully incorporated by reference for all jurisdictions in which such incorporation is permitted. Although dependent claims have single dependencies in accordance with U.S. practice, each of the features in any of the dependent claims can be combined with each of the features of one or more of the other dependent claims dependent upon the same independent claim or claims.

What is claimed is:

1. A vacuum devolatilizer for use in a polymer manufacturing or processing plant comprising:
a vacuum chamber having an inlet, an outlet, at least one vacuum port, and at least one stirrer shaft port for the entry of a stirrer shaft;
a stirrer shaft passing through the at least one stirrer shaft port and extending into the vacuum chamber, the stirrer shaft having an agitating means;
a stirrer shaft seal associated with each stirrer shaft port for sealing against the stirrer shaft, each stirrer shaft seal having an external portion outside of the vacuum chamber; and
at least one motor located outside the vacuum chamber for rotating the shaft,
the devolatilizer further comprising means for blanketing the external portion of at least one stirrer shaft seal with a low oxygen content gas or vapor.

2. A devolatilizer of claim 1 in which the vacuum chamber has two stirrer shaft ports and the stirrer shaft extends through each of those two stirrer shaft ports.

3. The devolatilizer of claim 1 in which the means for blanketing the external portion of each stirrer shaft seal with a gas that is substantially non reactive with polyolefins is an enclosure around each stirrer shaft seal, the enclosure being mounted on the outside of the vacuum chamber and being provided with a supply of a low oxygen content gas or vapor.

4. A devolatilizer of claim 3 in which each enclosure may be maintained under a positive pressure of a low oxygen content gas.

5. A devolatilizer of claim 3 in which each enclosure is provided with an inspection hatch.

6. A devolatilizer of claim 4 which includes a flow meter to monitor the flow of low oxygen content gas into each enclosure.

7. A devolatilizer of claim 1 in which the vacuum chamber is generally cylindrical and is horizontal such that the axis of the cylinder lies in a horizontal plane, and the stirrer shaft also extends horizontally and coincides with axis of the cylinder.

8. A devolatilizer of claim 1 in which each shaft seal is a packed seal and the devolatilizer comprises at least one oil injection pump for injecting lubricating oil into the packed seal.

9. A devolatilizer of claim 8 in which each seal contains a packing comprising braided Kevlar fibers, impregnated with PTFE or graphite.

10. A devolatilizer of claim 1 in which the low oxygen content gas is nitrogen.

11. A devolatilizer of claim 1 in which the internal volume of the vacuum chamber is at least 2 to 10 m³.

12. A polyolefin manufacturing plant comprising a vacuum devolatilizer as in claim 1.

13. A process of removing volatile components from a concentrated polymer phase comprising:
introducing the concentrated polymer phase into a vacuum devolatilizer comprising:
a vacuum chamber having an inlet, an outlet, at least one vacuum port, and at least one stirrer shaft port for the entry of a stirrer shaft;
a stirrer shaft passing through the at least one stirrer shaft port and extending into the vacuum chamber, the stirrer shaft having agitation means for agitating a concentrated polymer phase in the vacuum chamber;
a stirrer shaft seal associated with each stirrer shaft port for sealing against the stirrer shaft, each stirrer shaft seal having an external portion outside of the vacuum chamber; and
at least one motor located outside the vacuum chamber for rotating the stirrer shaft,
the devolatilizer further comprising means for blanketing the external portion of at least one stirrer shaft seal with a low oxygen content gas or vapor,
the process further including the steps of:
introducing a concentrated polymer phase into the vacuum chamber;
applying a vacuum through the at least one vacuum port while rotating the stirrer shaft, thereby agitating the concentrated polymer phase; and
blanketing the external portion of at least one of the stirrer shaft seals with a low oxygen content gas.

14. A vacuum devolatilizer for use in a polymer manufacturing or processing plant comprising:
a vacuum chamber having an inlet, an outlet, at least one vacuum port, and at least one stirrer shaft port for the entry of a stirrer shaft;
a stirrer shaft passing through the at least one stirrer shaft port and extending into the vacuum chamber, the stirrer shaft having agitation means;
a stirrer shaft seal associated with each stirrer shaft port for sealing against the stirrer shaft; and
at least one motor located outside the vacuum chamber for rotating the stirrer shaft,
in which each stirrer shaft seal is a packed seal and is provided with a dedicated oil injection pump for injecting lubricating oil into the packed seal.

15. A devolatilizer as claimed in claim 14 in which the housing has two stirrer shaft ports and the stirrer shaft extends through each of those two stirrer shaft ports, and each shaft port has a packed stirrer shaft seal, the devolatilizer further comprising two oil injection pumps, each oil injection pump being arranged to pump oil into the packing of one of the stirrer shaft seals.

16. A devolatilizer of claim 14 which comprises a food grade oil for injection into the packing of each shaft seal.

17. A devolatilizer of claims 14 further comprising means for blanketing an external portion outside of the vacuum chamber of each shaft seal with a low oxygen content gas.

18. The devolatilizer of claim 17 in which the means for blanketing the external portion of each shaft seal with a low oxygen content gas is an enclosure around each shaft seal, the enclosure being mounted on the outside of the housing and being provided with a supply of low oxygen content gas or vapor.

19. A devolatilizer of claim 18 in which each enclosure may be maintained under a positive pressure of the low oxygen content gas.

20. A devolatilizer of claim 18 in which each enclosure is provided with an inspection hatch.

21. A devolatilizer of claim 18 which includes a flow meter to monitor the flow of low oxygen content gas or vapor into each enclosure.

22. A devolatilizer of claim 14 in which the vacuum chamber is generally cylindrical and is horizontal such that the axis of the cylinder lies in a horizontal plane, and the stirrer shaft also extends horizontally and coincides with axis of the cylinder.

23. A devolatilizer of claim 14 in which each seal contains a packing comprising braided Kevlar fibers, impregnated with PTFE or graphite.

24. A devolatilizer of claim 14 in which the low oxygen content gas is nitrogen.

25. A devolatilizer of claim 14 in which the internal volume of the vacuum chamber is at least 2 to 10 m³.
